(19) United States
(12) Patent Application Publication
(10) Pub. No.: US 2017/0227097 A1
(43) Pub. Date: Aug. 10, 2017

(54) ACTUATOR PIN RAMP-UP ASSEMBLY

(71) Applicant: Schaeffler Technologies AG & Co. KG, Herzogenaurach (DE)

(72) Inventors: Guihui ZHONG, Charlotte, NC (US); Marion Jack INCE, Mount Holly, NC (US)

(73) Assignee: Schaeffler Technologies AG & Co. KG, Herzogenaurach (DE)

(21) Appl. No.: 15/015,637

(22) Filed: Feb. 4, 2016

(51) Int. Cl. F16H 25/18

(52) U.S. Cl. CPC F16H 25/186

(57) ABSTRACT

An actuator arrangement including an actuator assembly and a rotor is disclosed. The actuator assembly includes a plate and at least three actuator pins attached to the plate, each including a cup and a contact element captively retained with the cup. The rotor is arranged axially adjacent to the plate and includes a corresponding number of receiving paths contoured to the actuator pins and configured to accommodate the contact elements. The rotor is movable between at least a first rotational position and a second rotational position such that in the first rotational position a first axial distance is defined between the plate and the rotor, and in the second rotational position a second axial distance is defined between the plate and the rotor that is greater than the first axial distance and greater than a diameter of a smaller one of a cup diameter or a contact element diameter.

### FIELD OF INVENTION

The present invention relates to an actuator and is more particularly related to an axial actuator including a plate and a rotor.

### BACKGROUND

Actuators are used in a variety of applications, including clutch assemblies that require axial actuation to connect or disconnect a shaft system. Some known varieties of actuators include a rotor and a plate including ball ramp-up assemblies, wherein a ball arranged between the rotor and the plate is guided within a contoured receiving path of the rotor. In known ball ramp-up actuators, the axial actuation distance is limited by the diameter of the balls used in the ball ramp-up assemblies, and the balls are loosely arranged between the plate and the rotor. Other known ball ramp-up actuators include cages with ball elements loosely arranged within the cages. These ball ramp-up actuators are problematic due to the ball elements escaping the detents or cup elements, particularly during shipping, assembly, or operation.

It would be desirable to provide an improved actuator assembly that allows an increased actuation distance between the plate and the rotor and simultaneously ensures retention of the ball elements.

### SUMMARY

An actuator arrangement featuring a larger axial actuation distance capacity and a more convenient actuator sub-assembly is provided. The actuator arrangement includes an actuator assembly having a plate and at least three actuator pins attached to the plate. Each of the at least three actuator pins includes a cup and a contact element captively retained with the cup. A rotor is arranged axially adjacent to the plate and includes a corresponding number of contoured receiving paths to the actuator pins that are configured to receive the contact elements. The rotor is movable between at least a first rotational position and a second rotational position such that (a) in the first rotational position a first axial distance is defined between the plate and the rotor, and (b) in the second rotational position a second axial distance is defined between the plate and the rotor that is greater than the first axial distance and is greater than a diameter of the smaller of a cup diameter or a contact element diameter.

### BRIEF DESCRIPTION OF THE DRAWINGS

The foregoing Summary and the following detailed description will be better understood when read in conjunction with the appended drawings, which illustrate a preferred embodiment of the invention. In the drawings:

FIG. 1 is a cross sectional view of an actuator arrangement according to a first embodiment of the invention.

FIG. 2 is an exploded perspective view of the actuator arrangement of FIG. 1.

FIG. 3A is a cross sectional view of a first embodiment of an actuator pin of the actuator arrangement of FIGS. 1 and 2.

FIG. 3B is a cross sectional view of an alternative actuator pin for the actuator arrangement.

FIG. 3C is a cross sectional view of a second embodiment of an actuator pin for the actuator arrangement.

FIG. 3D is a schematic view of the actuator pin of FIG. 3A engaging a receiving path of a rotor of the actuator arrangement.

FIG. 4A is a cross sectional view of the actuator arrangement of FIGS. 1 and 2 with a rotor in a first rotational position.

FIG. 4B is a cross sectional view of the actuator arrangement of FIGS. 1 and 2 with the rotor in a second rotational position.

FIG. 5A is an axial view of a rotor according to a first embodiment for the actuator arrangement of FIGS. 1 and 2.

FIG. 5B is a perspective view of a rotor according to a second embodiment.

FIG. 5C is a perspective view of a rotor according to a third embodiment.

FIG. 5D is a perspective view of a rotor according to a fourth embodiment.

FIG. 5E is a perspective view of a rotor according to a fifth embodiment.

FIG. 6A is a schematic view of a first embodiment of a profile for a receiving path on the rotor of the actuator arrangement of FIGS. 1 and 2.

FIG. 6B is a schematic view of a second embodiment of a profile for a receiving path on the rotor of the actuator arrangement of FIGS. 1 and 2.

FIG. 6C is a schematic view of a third embodiment of a profile for a receiving path on the rotor of the actuator arrangement of FIGS. 1 and 2.

FIG. 6D is a schematic view of a fourth embodiment of a profile for a receiving path on the rotor of the actuator arrangement of FIGS. 1 and 2.

FIG. 6E is a schematic view of a fifth embodiment of a profile for a receiving path on the rotor of the actuator arrangement of FIGS. 1 and 2.

FIG. 7A is a cross sectional view of an actuator arrangement according to a second embodiment of the invention.

FIG. 7B is an exploded perspective view of the actuator arrangement of FIG. 7A.

FIG. 7C is a magnified view of a preload assembly of FIGS. 7A and 7B.

### DETAILED DESCRIPTION OF THE PREFERRED EMBODIMENTS

Certain terminology is used in the following description for convenience only and is not limiting. The words “front,” “rear,” “upper,” and “lower” designate directions in the drawings to which reference is made. The words “inwardly” and “outwardly” refer to directions toward and away from the parts referenced in the drawings. “Axially” refers to a direction along the axis of a shaft or rotating part. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

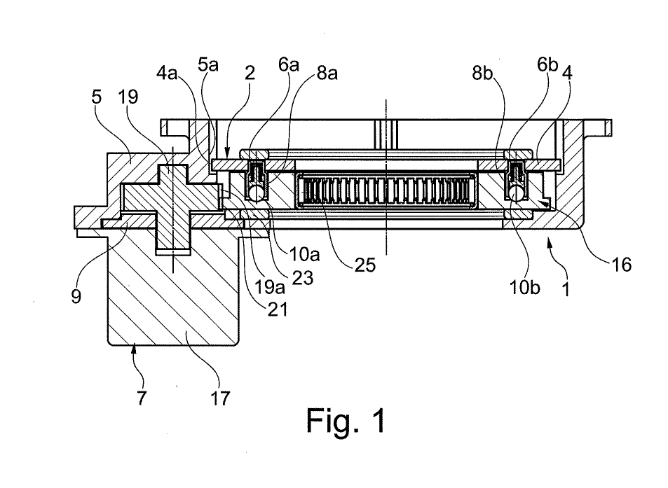

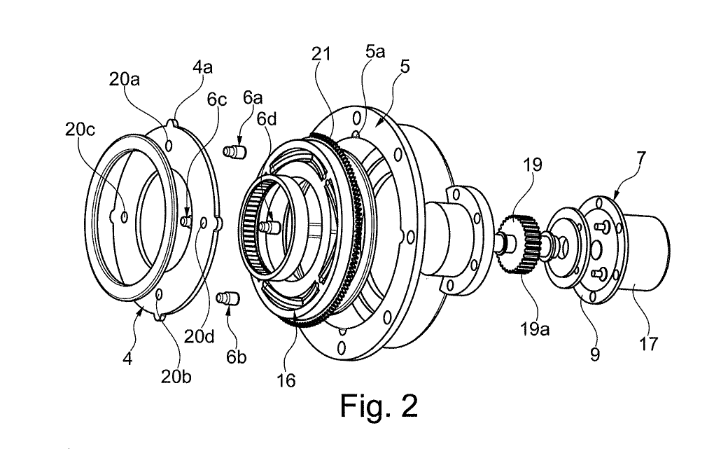

As shown in FIGS. 1 and 2, a first embodiment of an actuator arrangement 1 is disclosed. The actuator arrangement 1 includes an actuator assembly 2 including a plate 4 and actuator pins 6a, 6b, 6c, 6d attached to the plate 4. The actuator pins 6a, 6b, 6c, 6d preferably each includes a cup 8 and a contact element 10 captively retained within the cup 8. The contact elements 10 are preferably spherical rolling elements.

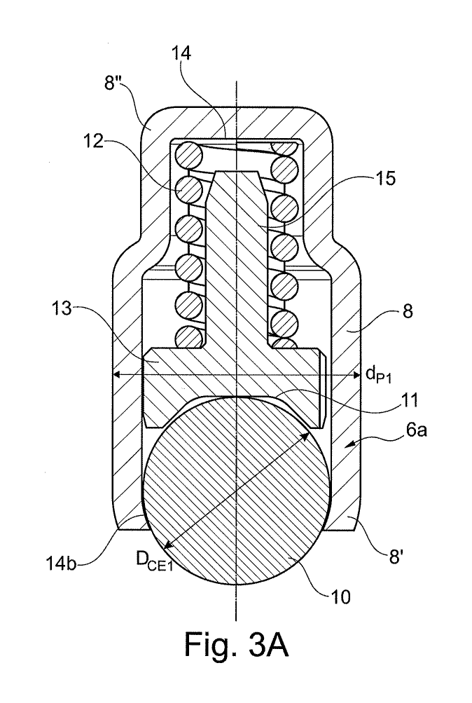

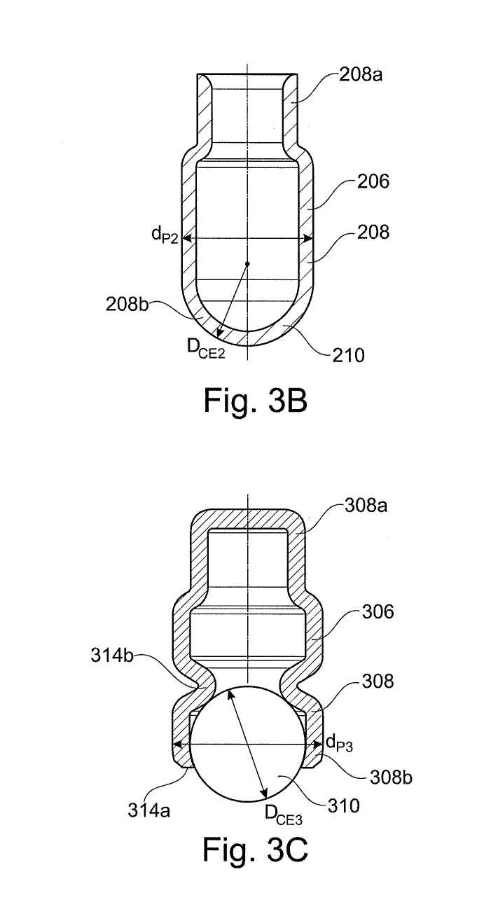

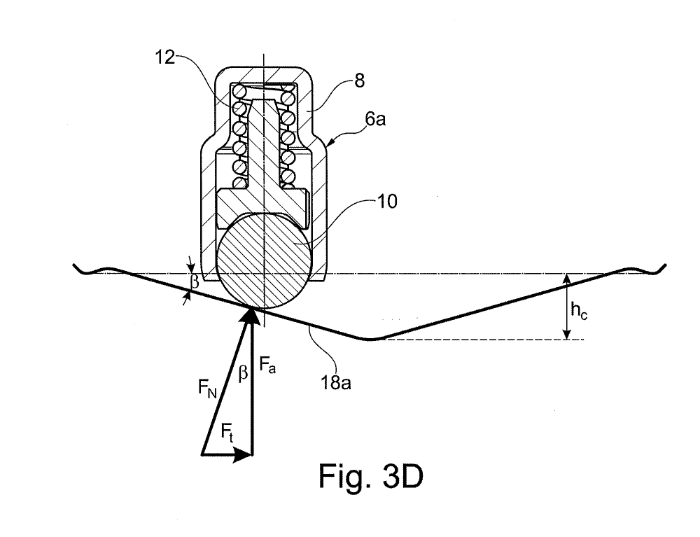

FIG. 3A shows a first one of the actuator pins 6a preferably includes a biasing element 12 arranged between a base 14 of the cup 8 and the contact element 10. As shown in FIG. 3A, a support element 13 provides a support surface 11 for the contact element 10 at a first axial end and includes an extension 15 at a second axial end that is configured to be at least partially received within the biasing element 12. The biasing element 12 is preferably a coil spring, and the extension 15 can be received within the coils. The cup 8 preferably includes a stepped profile, with a larger outer diameter a first axial end 8′ from which the contact element 10 protrudes, and a smaller outer diameter at a second axial end 8″ which is received within the bore 20a of the plate 4. The support element 13 preferably has a larger diameter than a diameter of the extension 15. The cup 8 includes a retention lip 14b on an axial end opposite from the base 14 that is configured to captively secure the contact element 10 within the cup 8. The retention lip 14b provides 360° of retention in a circumferential direction such that a reliable retention arrangement is provided for the contact elements 10. As shown in FIG. 3A, the cup 8 has a diameter dₚ₁ that is preferably greater than a diameter D_{CE1} of the contact element 10. The actuator pins 6b, 6c, 6d are constructed in the same manner.

In the embodiment shown in FIG. 2, four actuator pins 6a, 6b, 6c, 6d are provided and the plate 4 includes four bores 20a, 20b, 20c, 20d. Once assembled, each of the cups 8 of the actuator pins 6a, 6b, 6c, 6d is fixed within a respective one of the four bores 20a, 20b, 20c, 20d. One of ordinary skill in the art recognizes that the number of actuator pins can be varied, depending on the characteristics of a particular application.

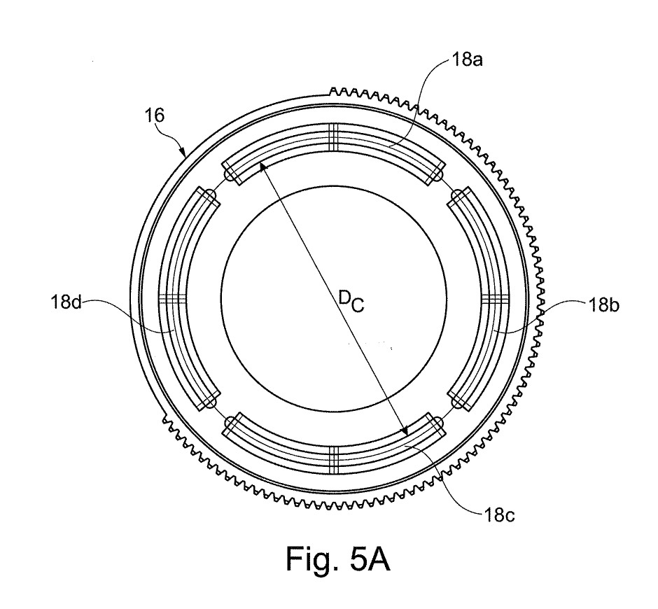

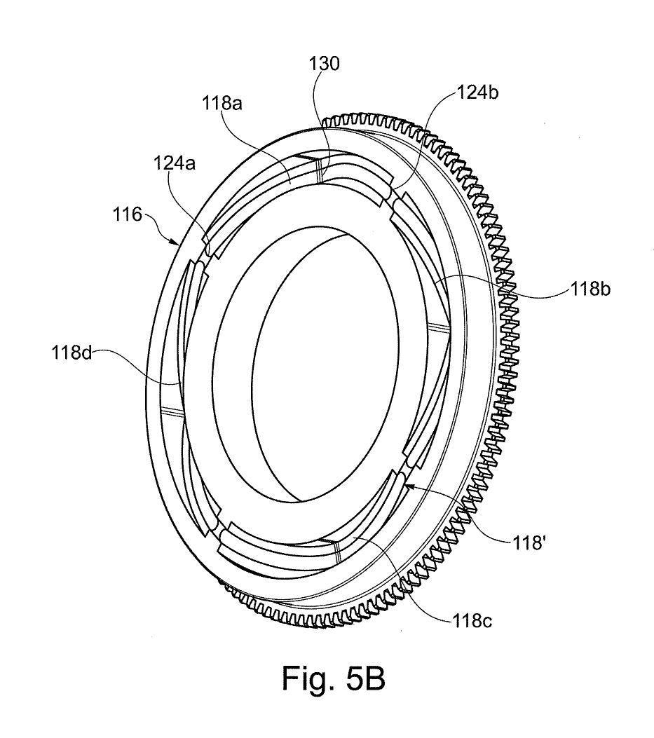

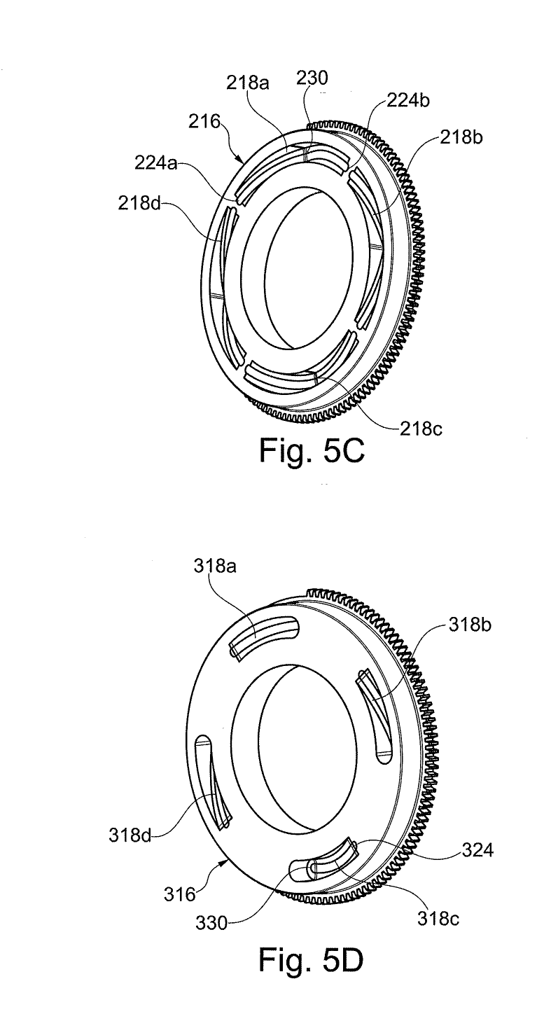

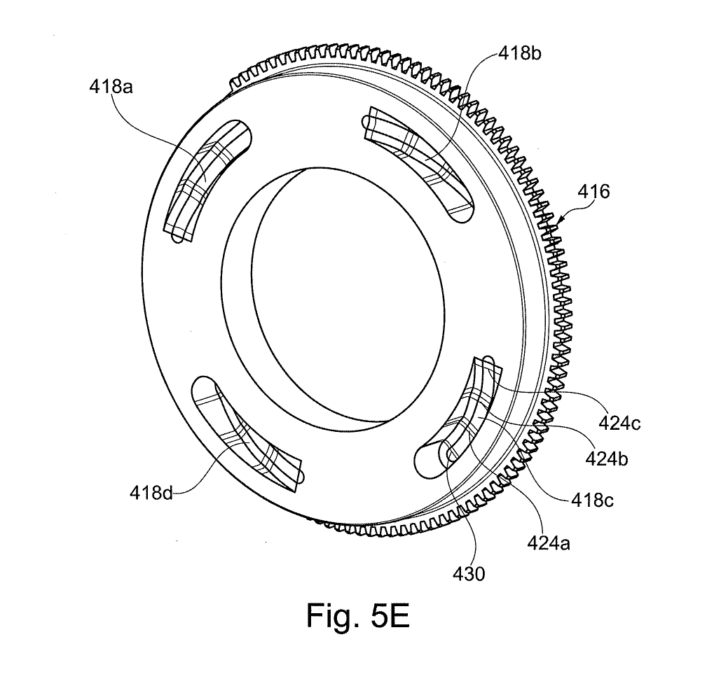

A rotor 16 is arranged axially adjacent to the plate 4 and the rotor includes a corresponding number of contoured receiving paths 18a, 18b, 18c, 18d, shown in FIG. 5A, that receive the actuator pins 6a, 6b, 6c, 6d and configured to accommodate the contact elements 10 of the actuator assembly 2. As shown in FIG. 1, the rotor 16 is supported in a radially inward direction by a radial support bearing 25, and includes rotor teething 21 on a radially outer surface that are described in more detail below. The radial support bearing 25 is preferably a sleeve. The rotor 16 is supported in an axial direction by an axial support bearing 23. The axial support bearing 23 is preferably a thrust washer. An axial view of the a first embodiment of the rotor 16, which more clearly shows the arrangement of the contoured receiving paths 18a, 18b, 18c, 18d, is shown in FIG. 5A.

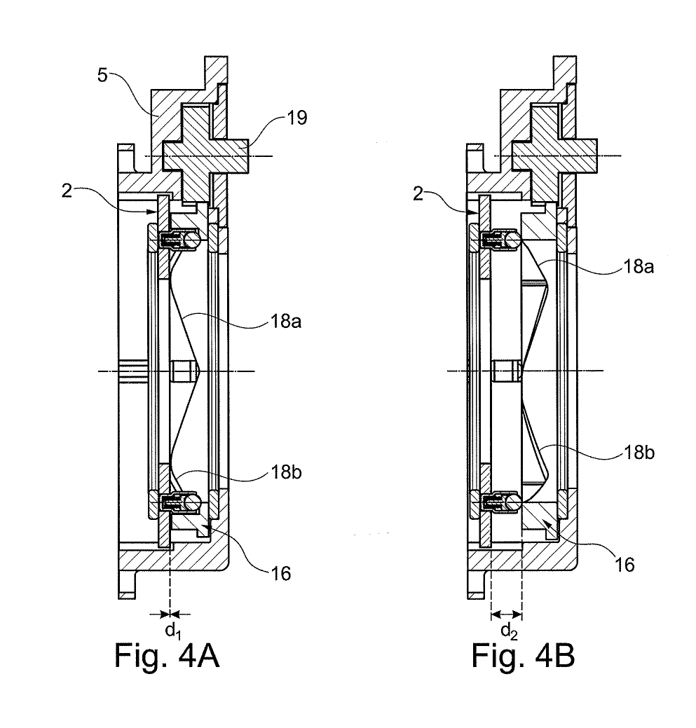

As shown in FIGS. 4A and 4B, the rotor 16 is selectively movable between at least a first rotational position and a second rotational position. As shown in FIGS. 1 and 2, in a preferred embodiment, the rotational position of the rotor 16 is controlled by a motor assembly 7 mounted in a housing 5 that includes housing teeth 5. As shown in FIGS. 1 and 2, the plate 4 is mounted within the housing 5, and the plate 4 includes plate teeth 4a that are configured to engage with the housing teeth 5a such that the plate 4 is rotationally fixed. The motor assembly 7 includes a motor 17 with a cover mounting plate 9 and an input gear 19 with input gear teething 19a. The motor 17 rotationally drives the input gear 19, and the input gear teething 19a are configured to engage the rotor teething 21 located on a periphery of the rotor 16. The motor 17 is selectively actuated to drive the input gear teething 19a in either the clockwise or counter-clockwise direction, which then drives the rotor 16 between a plurality of rotational positions.

In the first rotational position of the rotor 16 shown in FIG. 4A, a first axial distance d₁ is defined between the plate 4 and the rotor 16. The first axial distance d1 is illustrated as a minimal distance between the plate 4 and the rotor 16 in FIG. 4A. One of ordinary skill in the art recognizes that there could be no axial gap between the plate 4 and the rotor 16, i.e. the plate 4 and the rotor 16 axially abut each other in the first rotational position of the rotor 16. In the second rotational position shown in FIG. 4B, a second axial distance d₂ is defined between the plate 4 and the rotor 16 that is greater than the first axial distance d₁ and greater than a diameter of the smaller of (1) the diameter D_{CE1} of the contact elements 10 or (2) the diameter dₚ₁ of the cup 8 of the actuator pin. The cup 8 of the actuator pins 6a, 6b, 6c, 6d provide an increased actuation distance capacity. The axial actuation distance, i.e. the difference between the first axial distance d₁ and the second axial distance d₂, can be increased by increasing the axial height of the cup 8. The retention lip 14b of the cup 8 provides a reliable arrangement to captively secure the contact element 10a within the cup 8.

A schematic view of one of the receiving paths 18a of the rotor 16 is shown in FIG. 3D; the other receiving paths 18b, 18c, 18d would have the same contour. The receiving path 18a is formed as a groove or recess and has a contour slope angle β and a contour height h_{c}. The receiving paths 18a, 18b, 18c, 18d are arranged on a path diameter D_{C} that corresponds to the position of the actuator pins 6a, 6b, 6c, 6d, as shown in FIG. 5A. The following relationships are provided for the arrangement and design of the actuator pins 6a, 6b, 6c, 6d and the contours of the rotor 16:

Fₜ=Fₐ*tan(β)

Tᵣ=0.5n*Fₜ*D_{c}=0.5n*Fₐ*D_{c}*tan(β)

Fₐ=2Tᵣ/[n*D_{c}*tan(β)]

F_{A}=n*Fₐ=2Tᵣ/[D_{c}*tan(β)]

In the above relationships, Tₐ corresponds to an activation torque, F_{A} corresponds to a total actuation force, n corresponds to the number of actuator pins, F_{N} corresponds to a normal force of the contact element 10 on the receiving path 18a, and Fₜ corresponds to a traction force experienced by the contact element 10 along the receiving path 18a, as illustrated in FIG. 3D.

FIG. 3B illustrates an alternative actuator pin 206 that can be substituted for the actuator pins 6a, 6b, 6c, 6d. The actuator pin 206 includes a cup 208 with an open first axial end 208a and a rounded contact element 210 at a second axial end 208b. The rounded contact element 210 is preferably formed as a hemispherical rounded head. The rounded contact element 210 is configured to engage within the receiving paths 18a, 18b, 18c, 18d of the rotor 16, in exactly the same manner as described above with respect to the contact element 10. Similar to the configuration of the actuator pins 6a, 6b, 6c, 6d, the axial height of the actuator pin 206 can be maximized to increase the effective axial actuation distance between the rotor 16 and the plate 4. As shown in FIG. 3B, the cup 208 has a diameter dₚ₂ and the rounded contact element 210 has a diameter D_{CE2}. The second axial distance d₂ between the plate 4 and the rotor 16 is greater than the first axial distance d₁ and greater than a diameter of the smaller of (1) the diameter D_{CE2} of the rounded contact element 210 or (2) the diameter dₚ₂ of the cup 208. One of ordinary skill in the art will recognize from the present disclosure that the curvature of the rounded contact element 210 could be greatly increased, such that the diameter D_{CE2} of the rounded contact element 210 is very large. In this embodiment, the axial actuation distance would be larger than the diameter dₚ₂ of the cup 208, since the diameter dₚ₂ of the cup 208 is smaller than the diameter D_{CE2} of the rounded contact element 210.

FIG. 3C illustrates a second embodiment of an actuator pin 306 that can be substituted for the first embodiment of actuator pins 6a, 6b, 6c, 6d. The actuator pin 306 lacks any biasing spring and instead relies on a retention lip 314a at an axial end 308b of a housing 308 for engaging a first half of a spherical element 310 and a retention shoulder 314b in a medial region of the housing 308 for engaging a second half of the spherical element 310. Similar to the configuration of the actuator pins 6a, 6b, 6c, 6d, the axial height of the actuator pin 306 can be maximized to increase the effective axial actuation distance between the rotor 16 and the plate 4. As shown in FIG. 3C, the pin housing body 308 has a diameter dₚ₃ in a region of the contact element 310, and the contact element 310 has a diameter D_{CE3}. In this embodiment, the second axial distance d₂ between the plate 4 and the rotor 16 is greater than the first axial distance d₁ and greater than a diameter of the smaller of (1) the diameter D_{CE3} of the contact element 310 or (2) the diameter dₚ₃ of the cup 308. Similar to the embodiment shown in FIG. 3A, the design of the actuator pins and the contact elements are designed to ensure that the axial actuation distance is greater than a diameter of the spherical contact elements 10, 310.

One of ordinary skill in the art will also recognize from the present disclosure that a variety of contours can be provided in the rotor 16. For example, a second embodiment of the rotor 116 is shown in FIG. 5B with the receiving paths 118a, 118b, 118c, 118d extending as a circumferentially extending, continuous groove 118′. As shown in FIG. 5B, a first actuation position 124a is provided at a first end of the receiving path 118a and a second actuation position 124b is provided at a second end of the receiving path 118a, and a resting position 130 is provided between the actuation positions 124a, 124b. Although not specifically illustrated, each of the receiving paths 118a, 118b, 118c, 118d of this embodiment includes two actuations positions and one resting position, and adjacent receiving paths 118a, 118b, 118c, 118d all have the same contour.

In a third embodiment of the rotor 216 shown in FIG. 5C, the receiving paths 218a, 218b, 218c, 218d of the rotor 216 do not connect to form a circumferentially extending, continuous groove. In contrast to the second embodiment of the rotor 116 described above, the receiving paths 218a, 218b, 218c, 218d of the third embodiment of the rotor 216 do not overlap or have common actuation positions. Each receiving path 218a, 218b, 218c, 218d have the same contour and include two actuation positions and one resting position, although the actuation positions 224a and 224b and resting position 230 are only labeled for receiving path 218a in FIG. 5C.

In a fourth embodiment of the rotor 316 shown in FIG. 5D, the rotor 316 includes receiving paths 318a, 318b, 318c, 318d that are circumferentially spaced apart from each other. Each of the receiving paths 318a, 318b, 318c, 318d have the same contour and include one actuation position and one resting position, although the actuation position 324 and the resting position 330 are only labeled for receiving path 318c in FIG. 5D.

In a fifth embodiment of the rotor 416 shown in FIG. 5E, the rotor 416 includes receiving paths 418a, 418b, 418c, 418d having the same contour that are circumferentially spaced apart and each include a first actuation position, a second actuation position, a third actuation position, and a resting position. In FIG. 5E, the first actuation position 424a, second actuation position 424b, third actuation position 424c, and resting position 430 are only labeled for receiving path 418c. One of ordinary skill in the art will recognize from the present disclosure that any combination of the features shown for the five embodiments of the rotor could be used.

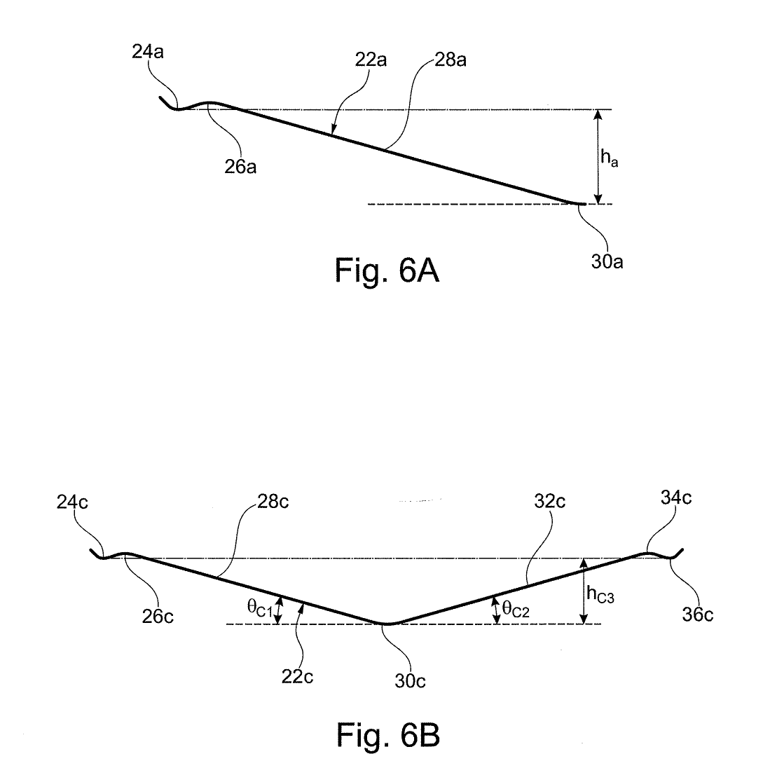

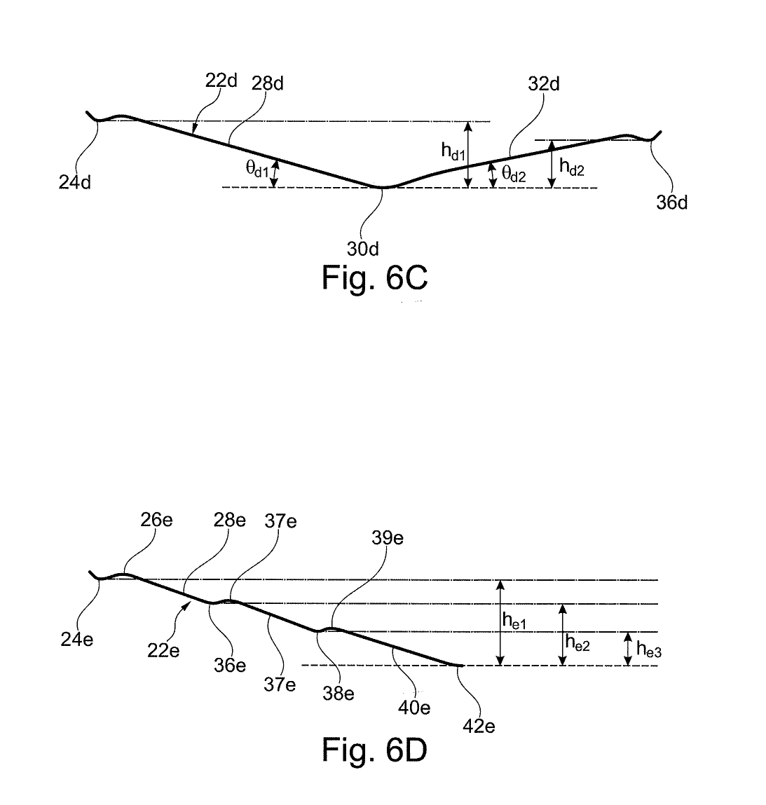

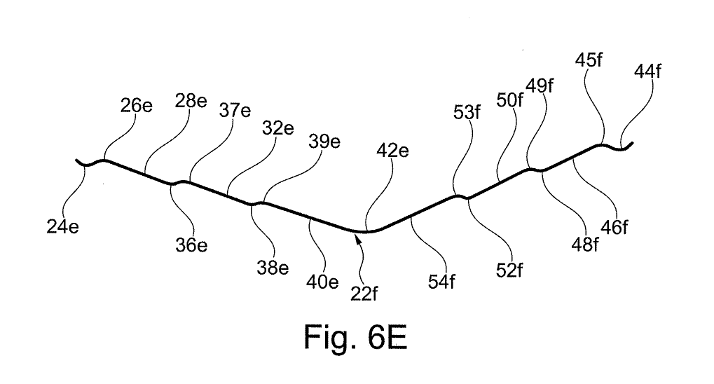

One of ordinary skill in the art will also recognize from the present disclosure that a variety of designs and contours can be used for the receiving path 18 to achieve varying actuation states. As shown in FIG. 6A, a first embodiment of a profile 22a of the receiving path includes a first actuation position 24a, a first protrusion 26a, a first contoured slope region 28a, and a resting position 30a. In FIG. 6A, the first contoured slope region 28a extends in a clockwise circumferential direction from the first actuation position 24a to the resting position 30a. One of ordinary skill in the art recognizes that the first contoured slope region could extend in a counter-clockwise circumferential direction. As shown in FIG. 6A, the first actuation position 24a has a first height hₐ from the resting position 30a. The height of the resting positions can be varied depending on a specific application to increase the actuation distance.

As shown in FIG. 6B, a second embodiment of a profile 22c of the receiving path 18 includes a first actuation position 24c, a first protrusion 26c, a first contoured slope region 28c, and a resting position 30c, a second contoured slope region 32c, a second protrusion 34c, and a second actuation position 36c. As shown in FIG. 6B, the first contoured slope region 28c extends in a clockwise direction from the first actuation position 24c, and the second contoured slope region 32c extends in a counter-clockwise direction from the second actuation position 36c. One of ordinary skill in the art recognizes from the present disclosure that these directions could be reversed. The second embodiment of the profile 22c of the receiving path 18 includes a first angle θ_{c1} of the first contoured slope region 28c that is congruent to a second angle θ_{c2} of the second contoured slope region 32c. As shown in FIG. 6B, the first actuation position 24c and the second actuation position 36c are arranged at the same height h_{c3} from the resting position 30c.

As shown in FIG. 6C, a third embodiment of a profile 22d of the receiving path 18 includes a first angle θ_{d1} of a first contoured slope region 28d is greater than a second angle θ_{d2} of a second contoured slope region 32d. As shown in FIG. 6C, a second height h_{d2} of the second actuation position 36d is less than a first height h_{d1} of the first actuation position 24d from the resting position 30d.

As shown in FIG. 6D, a fourth embodiment of a profile 22e of the receiving path 18 includes a first actuation position 24e, a first protrusion 26e, a first contoured slope region 28e extending from the first actuation position 24e, a second actuation position 36e, a second protrusion 37e, a second contoured slope region 32e extending from the second actuation position 36e, a third actuation position 38e, a third protrusion 39e, a third contoured slope region 40e extending from the third actuation position 38e, and a resting position 42e. As shown in FIG. 6D, the first actuation position 24e has a first height hₑ₁ from the resting position 42, the second actuation position 36e has a second height hₑ₂ from the resting position 42e that is less than the first height hₑ₁, and the third actuation position 38e has a third height hₑ₃ from the resting position 42e that is less than the first height hₑ₁ and the second height hₑ₂.

As shown in FIG. 6E, a fifth embodiment of a profile 22f of the receiving path 18 includes a first half that is identical to the fourth embodiment of the profile 22e. The other half of the profile 22f of the fifth embodiment includes a fourth actuation position 44f, a fourth protrusion 45f, a fourth contoured slope region 46f extending from the fourth actuation position 44f, a fifth actuation position 48f, a fifth protrusion 49f, a fifth contoured slope region 50f extending from the fifth actuation position 48f, a sixth actuation position 52f, a sixth protrusion 53f, and a sixth contoured slope region 53f extending from the sixth actuation position 52f towards the resting position. One of ordinary skill in the art would recognize from the present disclosure that the height for the first actuation position 24e, second actuation position 36e, third actuation position 38e, fourth actuation position 44f, fifth actuation position 48f, and sixth actuation position 52f can be varied. One of ordinary skill in the art would also recognize that multiple actuation positions can be provided.

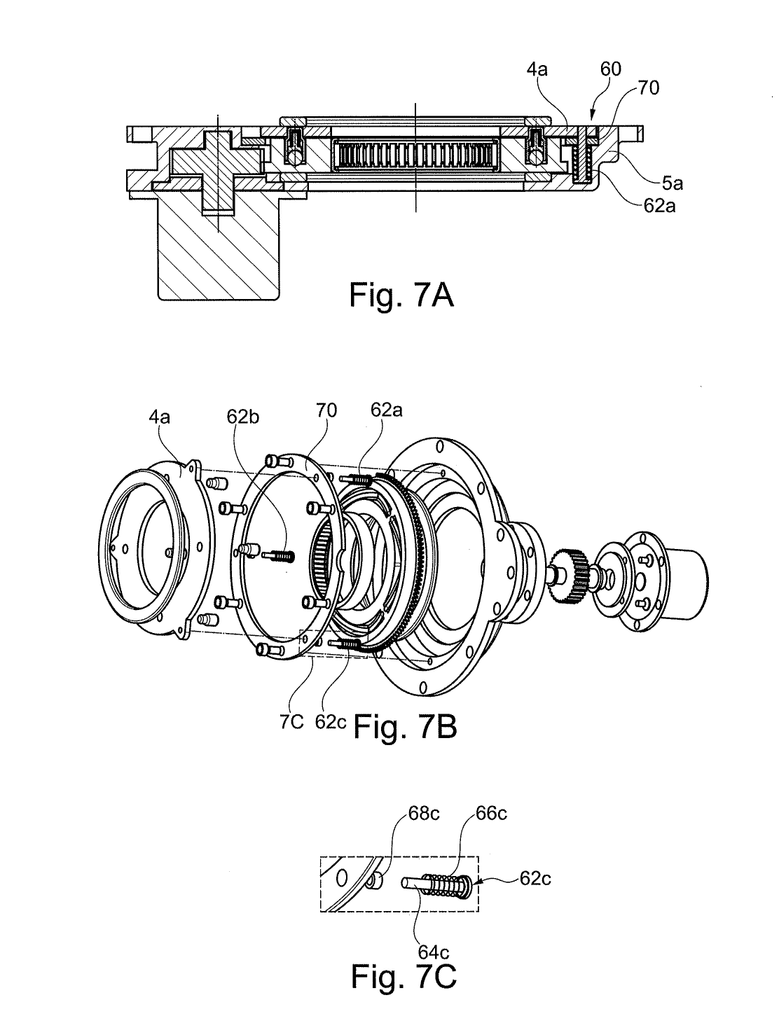

As shown in FIGS. 7A-7C, a second embodiment of the actuator arrangement 60 is shown that is the same as the first actuator 1 except that at least three preload assemblies 62a, 62b, 62c are provided. Each of the at least three preload assemblies 62a, 62b, 62c includes a preload pin 64a, 64b, 64c, a preload spring 66a, 66b, 66c, and a guide sleeve 68a, 68b, 68c. FIG. 7C shows an enlarged view of one of the preload assemblies 62c. A preload mount plate 70 is fixed to the housing 5a to position the preload assemblies 62a, 62b, 62c in their respective positions. The preload pins 64a, 64b, 64c are pressed into the plate 4a, and the guide sleeves 68a, 68b, 68c are pressed into the preload mount plate 70. The actuation process, i.e. movement from the first rotational position to the second rotational position of the rotor 16, is similar as described above with respect to the first embodiment of the actuator arrangement, but movement of the plate 4a in the second embodiment from the activated position to the deactivated position differs from the first embodiment of the actuator arrangement 1. Instead of relying on external preloads to return the plate 4a back to the resting position, the preload springs 64a, 64b, 64c of the preload assemblies 62a, 62b, 62c bias the plate 4a axially towards to the resting position.

Having thus described the present invention in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

What is claimed is:

1. An actuator arrangement comprising:
an actuator assembly including a plate and at least three actuator pins attached to the plate, each of the at least three actuator pins including a cup and a contact element secured with the cup; and
a rotor arranged axially adjacent to the plate, the rotor including a corresponding number of contoured receiving paths to the actuator pins and configured to accommodate the contact elements, the rotor being movable between at least a first rotational position and a second rotational position such that in the first rotational position a first axial distance is defined between the plate and the rotor, and in the second rotational position a second axial distance is defined between the plate and the rotor that is greater than the first axial distance and is greater than a diameter of a smaller one of a cup diameter or a contact element diameter.

2. The actuator arrangement of claim 1, wherein each of the at least three actuator pins includes a biasing element arranged between a base of the cup and the contact element.

3. The actuator arrangement of claim 1, wherein the contact element is a spherical element and each of the at least three actuator pins include a retention lip at an axial end of a housing for engaging a first half of the spherical element, and a retention shoulder in a medial region of the housing for engaging a second half of the spherical element.

4. The actuator arrangement of claim 1, wherein the cups of the at least three actuator pins each include a retention lip at an axial end configured to captively secure the contact element within the cup.

5. The actuator arrangement of claim 1, wherein the contact element is integrally formed with the cup as a hemispherical rounded head.

6. The actuator arrangement of claim 1, wherein there are four of the actuator pins, and the plate includes four bores, and each of the cups is fixed within a respective one of the four bores.

7. The actuator arrangement of claim 1, wherein the receiving paths extend as a circumferentially extending, continuous groove.

8. The actuator arrangement of claim 1, wherein a profile of each of the receiving paths includes a first actuation position, a first protrusion, a first contoured slope region, and a resting position.

9. The actuator arrangement of claim 8, wherein the profile further includes a second contoured slope region, a second protrusion, and a second actuation position.

10. The actuator arrangement of claim 9, wherein the first contoured slope region extends in a clockwise direction from the resting position, and the second contoured slope region extends in a counter-clockwise direction from the resting position.

11. The actuator arrangement of claim 9, wherein a first angle of the first contoured slope region is congruent to a second angle of the second contoured slope region.

12. The actuator arrangement of claim 1, wherein a profile of each of the receiving paths includes a first actuation position, a first contoured slope region extending from the first actuation position, a second actuation position, a second contoured slope region extending from the second actuation position, a third actuation position, a third contoured slope region extending from the third actuation position, and a resting position.

13. The actuator arrangement of claim 12, further comprising a fourth actuation position, a fourth contoured slope region extending from the fourth actuation position, a fifth actuation position, a fifth contoured slope region extending from the fifth actuation position, a sixth actuation position, and a sixth contoured slope region extending from the sixth actuation position towards the resting position.

14. The actuator arrangement of claim 1, wherein a motor assembly rotationally adjusts the rotor between the first rotational position and the second rotational position.

15. The actuator arrangement of claim 14, wherein the motor assembly includes an input gear with input gear toothing, and the rotor includes a rotor toothing on a periphery of the rotor, and the input gear toothing is configured to engage with the rotor teething.

16. An actuator arrangement comprising:
an actuator assembly including a plate and at least three actuator pins attached to the plate, each of the at least three actuator pins including a cup and a contact element secured with the cup; and
a rotor arranged axially adjacent to the plate, the rotor including a corresponding number of contoured receiving paths to the actuator pins and configured to accommodate the contact elements, the rotor being movable between at least a first rotational position and a second rotational position such that in the first rotational position a first axial distance is defined between the plate and the rotor, and in the second rotational position a second axial distance is defined between the plate and the rotor that is greater than the first axial distance.

17. The actuator arrangement of claim 16, wherein each of the at least three actuator pins includes a biasing element arranged between a base of the cup and the contact element.

18. The actuator arrangement of claim 16, wherein the contact element is a spherical element and each of the at least three actuator pins include a retention lip at an axial end of a housing for engaging a first half of the spherical element, and a retention shoulder in a medial region of the housing for engaging a second half of the spherical element.

19. The actuator arrangement of claim 16, wherein the cups of the at least three actuator pins each include a retention lip at an axial end configured to captively secure the contact element within the cup.

20. The actuator arrangement of claim 16, wherein the contact element is integrally formed with the cup as a hemispherical rounded head.
